(19) United States
(12) Patent Application Publication
(10) Pub. No.: US 2011/0035592 A1
(43) Pub. Date: Feb. 10, 2011

(54) AUTHENTICATION METHOD SELECTION USING A HOME ENHANCED NODE B PROFILE

(75) Inventors: Inhyok Cha, Yardley, PA (US); Yogendra Shah, Exton, PA (US); Andreas Schmidt, Frankfurt (DE)

Correspondence Address: Woodcock Washburn LLP, 2929 Arch Street, Cira Centre, 12th Floor, Philadelphia, PA, 19104, US

(73) Assignee: INTERDIGITAL PATENT HOLDINGS, INC., Wilmington, DE (US)

(21) Appl. No.: 12/650,728

(22) Filed: Dec. 31, 2009

Related U.S. Application Data
(60) Provisional application No. 61/141,697, filed on Dec. 31, 2008.

(51) Int. Cl. H04L 9/00

(52) U.S. Cl. 713/169

(57) ABSTRACT

An authentication method selection using a home enhanced Node B (H(e)NB) profile is disclosed. A method for selecting an H(e)NB authentication method includes authenticating at least one of the device or the hosting party module by a security gateway (SeGW). The SeGW receives a request from the H(e)NB to start the authentication process. Based on information received from the H(e)NB and an authentication information server, the SeGW determines how to authenticate the H(e)NB. The possible authentication methods include device authentication only, device authentication and hosting party module authentication, requesting the H(e)NB to perform authentication using Extensible Authentication Protocol-Authentication and Key Agreement, or authentication of both the H(e)NB and one or more WTRUs connected to or attempting to connect to the H(e)NB.

### CROSS REFERENCE TO RELATED APPLICATIONS

This application claims the benefit of U.S. provisional application No. 61/141,697 filed Dec. 31, 2008, which is incorporated by reference as if fully set forth herein.

### FIELD OF INVENTION

This application is related to wireless communications.

### BACKGROUND

A previous authentication method uses one round trip of message exchange sessions in an Internet Key Exchange (IKE) v2 protocol to establish an authentication method. A security gateway (SeGW) announces what it “wants” or what its “requirement is” from the home enhanced Node B (H(e)NB) in terms of the authentication method. The H(e)NB then announces what it “can do” or what its “capability is”. The SeGW then either accepts or rejects the H(e)NB announcement.

An issue of the previous authentication method is that due to the pre-announcement by the SeGW of the “requirement,” there is a possibility for mis-alignment between the H(e)NB and the SeGW. In other words, what the SeGW may want may differ from what the H(e)NB may be able to provide. This leads to an “error” or “rejection” condition. Another issue of this previous authentication method is that the SeGW can not select different authentication methods for different H(e)NBs since it sends the message first and the H(e)NB only responds. Therefore, there is no room for “customized” selection of H(e)NB authentication methods based on the characteristics/aspects of the individual H(e)NB itself. Rather, the previous method relies on a sweep-all type of “requirement” announcement followed by an individual H(e)NB's “capability” information.

Another previous authentication method uses one round trip of message exchange sessions in IKEv2 protocol where the party that needs to be authenticated (i.e., the “authenticatee”) sends information about its “capability”, i.e., “what it can do” (usually a set of possible choices that it is capable of), and the party that performs authentication (i.e., the “authenticator”) then chooses one of the capability settings to authenticate and further communicate with the authenticatee. A problem of this approach is that the authenticator then is “stuck with” the potentially limited information that the authenticatee presents to it in terms of its capabilities, and also does not use any other information that may be available in terms of the capabilities or preferences or the authenticate or any possible best methods of authentication known for the authenticate that should be used.

### SUMMARY

An authentication method selection using a home enhanced Node B (H(e)NB) profile is disclosed. The method for selecting an H(e)NB authentication method includes authenticating at least one of a device or a hosting party module by a security gateway (SeGW). The SeGW receives a request from the H(e)NB to start the authentication process. Based on information received from the H(e)NB and an authentication information server, the SeGW determines a method by which to authenticate the H(e)NB. The possible authentication methods include device authentication only, device authentication and hosting party module authentication, or requesting the H(e)NB to perform authentication using Extensible Authentication Protocol-Authentication and Key Agreement.

### BRIEF DESCRIPTION OF THE DRAWINGS

A more detailed understanding may be had from the following description, given by way of example in conjunction with the accompanying drawings wherein:

FIG. 1 is an example system architecture;

FIGS. 2A and 2B shows an example flow diagram of a method for selecting a home enhanced Node B (H(e)NB) authentication method;

FIGS. 3A and 3B shows an example flow diagram of an alternate method for selecting an H(e)NB authentication method; and

FIG. 4 shows an example flow diagram of yet another alternate method for selecting an H(e)NB authentication method.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node B, an enhanced or evolved Node B, a site controller, an access point (AP), a home Node B or an evolved home Node B (collectively called H(e)NB), a femto cell base station, a home gateway (HGW) that has cellular base station capabilities, a cable set-top box, a home gaming box, a home digital media distribution box, or any other type of interfacing device capable of operating in a wireless environment.

Disclosed herein is a system and architecture for deploying a home enhanced Node B and home Node B (collectively H(e)NB) for wireless communications and a description of authentication signaling between the H(e)NB and a secure gateway (SeGW) and the authentication methods that may be used to establish wireless communications. Methods for selecting an authentication method via a negotiation between the H(e)NB and the (SeGW) are disclosed herein. Although disclosed herein for authentication for an H(e)NB system, the method disclosed here in is applicable to all other interfacing device capable of operating in a wireless environment and serves as a base station or a gateway between WTRUs and wireless networks.

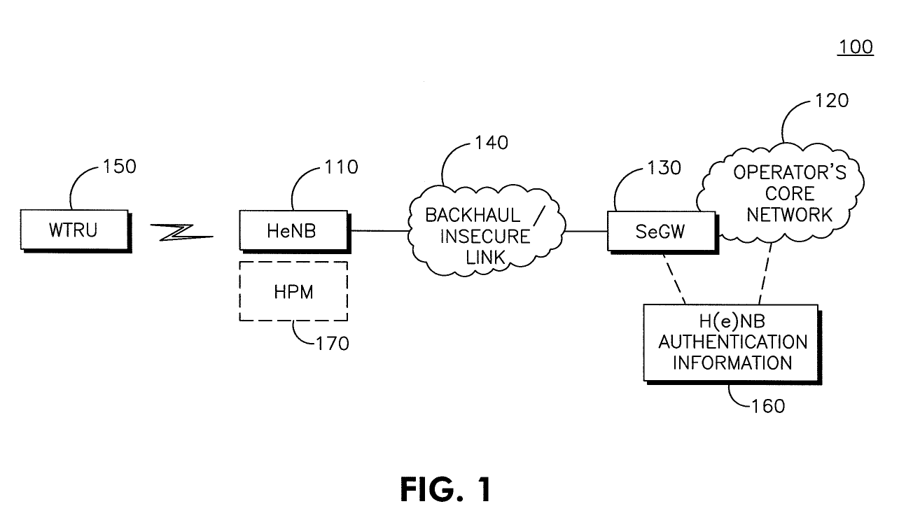

FIG. 1 is an example of security system architecture 100 for deployment of an H(e)NB 110. H(e)NB 110 accesses an operator's core network 120 via a SeGW 130. SeGW 130 represents an operator's core network 120 in performing mutual authentication with the H(e)NB 110. Mutual authentication may need support of an authentication server or a public key infrastructure (PM). The backhaul link 140 between H(e)NB 110 and SeGW 130 may be insecure, and a security tunnel may be established between H(e)NB 110 and SeGW 130 to protect information transmitted in backhaul link 140. H(e)NB 110 communicates with a WTRU 150 over an air interface. SeGW 130 communicates with a database server, such as H(e)NB authentication information server 160. The H(e)NB authentication information server 160 may communicate directly with the SeGW 130 or through the core network 120. The H(e)NB authentication information server 160 may be co-located with the SeGW 130 or may be remotely located. The H(e)NB authentication information server 160 may not be implemented as a physical server, but may be co-located with other functions. A hosting party module (HPM) 170 may be optionally connected to, or in communication with (collectively “connected to”), the H(e)NB 110 and the HPM 170 may be embodied by a universal integrated circuit card (UICC).

Disclosed herein are methods to help the SeGW 130 make a better selection of the H(e)NB authentication method using information stored and available in the database server, which may also be called an H(e)NB authentication information server or an H(e)NB profile server.

Selection of the authentication method may follow the following principles. It may be mandatory for an SeGW to support device, for example a H(e)NB, authentication using either a certificate or Extensible Authentication Protocol-Authentication and Key Agreement (EAP-AKA). It may be optional for an H(e)NB to support a combined authentication using the certificate or EAP-AKA for device authentication and EAP-AKA for a hosting party module (HPM) authentication. Selecting either 1) certification or EAP-AKA based device authentication or 2) certificate or EAP-AKA based device authentication and EAP-AKA based HPM authentication (combined authentication) may be a deployment-specific decision. Combined authentication is also referred to as multiple authentication herein.

The authentication method for the H(e)NB may also include, as part of the method, an authentication method or methods for the WTRUs (e.g. UEs) that connect to the H(e)NB. Under these conditions, the H(e)NB acts as a gateway or proxy for such WTRUs, toward the wireless network. The SeGW may authenticate the H(e)NB's authenticity, but may also authenticate the authenticity of the WTRUs that are either connected or attempting to connect to the H(e)NB. In the alternative the H(e)NB may simply extract any such authentication information about such WTRUs to another entity on the wireless network that will perform the task of authenticating such WTRUs. Authentication of the WTRUs may also be included as part of Combined Authentication.

In terms of authentication of WTRUs, the H(e)NB may also perform the role of “authenticator” itself, toward the WTRUs, on behalf of the network operator, and sends, as part of its own authentication information, a “summary” of the authentication information (such as results of the authentication of individual or group(s) of WTRUs), to the network operator, via the SeGW.

The SeGW has knowledge of operator policy and may be capable of dictating to the H(e)NB whether multiple authentication is required of it or not in an unambiguous manner. This implies that either all SeGWs are capable of multiple authentication, or if some SeGWs are not capable of multiple authentication, then the operator's policy for those SeGWs will clearly indicate that support of multiple authentication of the H(e)NB by these SeGWs is not required or possible.

Disclosed herein is that the SeGW's final decision on the outcome of the “authentication method selection” method may depend on operator policy, and also utilizes the available knowledge of an individual H(e)NB's characteristics, capabilities, preferences of the network operator, billing and charge related preferences, or other knowledge about preferred method of authenticating the H(e)NB. For example, based on an H(e)NB identification (H(e)NB ID) provided by the H(e)NB in a message, the SeGW may derive the authentication capabilities profile of the H(e)NB from the H(e)NB authentication information server which stores the H(e)NB authentication information profile, e.g. the authentication type of the H(e)NB. The SeGW may then decide whether to request certificate-based device authentication or EAP-AKA based authentication, based on the authentication profile. The H(e)NB authentication information server may also be referred to as an H(e)NB authentication profile server.

In general, during the initial interaction between the SeGW and the H(e)NB, the SeGW transmits or sends its “requirement” information. This is a preliminary or provisional requirement request to the H(e)NB based on “generic” information and not necessarily based on any prior knowledge of the individual H(e)NB itself. The SeGW then forwards the information received in the H(e)NB reply to the provisional requirement to the H(e)NB profile server in the network to find out more information about the individual H(e)NB's characteristics. For example, since the H(e)NB_ID information may already be carried in the first IKE_AUTH message, as discussed below, from the H(e)NB to the SeGW, this information should be utilized by the SeGW to make a final decision on the authentication method selection. The H(e)NB_ID information may also be carried in an earlier message.

Internet Key Exchange version 2 (IKEv2) may be used as a basic framework for secure communication (including those for authentication) between the H(e)NB and the core network. IKEv2 sets up a security association (SA) between the H(e)NB and the SeGW, and makes avail security keys that can be used for setting up an IPSec tunnel between the two entities. IKEv2 may also be used for combined authentication of the H(e)NB and the hosting party.

IKEv2 is a component of IPsec that is used for performing mutual authentication and establishing and maintaining security associations (SAs). In the context of the H(e)NB, the ‘end-point to security gateway tunnel’ is readily applicable. Thus, between the H(e)NB as an end-point and the SeGW, IKEv2 steps ensue that comprise of a first phase (IKE_SA_INIT) involving negotiation of security parameters for the IKE_SA and sending of random nonces and Diffie-Hellman values. The second phase (IKE_AUTH) then comprises request/response steps that include transmission of identities and setting up of an SA for the Authentication Header (AH) and/or Encapsulated Security Payload (ESP).

In a first embodiment, a SeGW may derive the authentication capabilities profile of the H(e)NB from an H(e)NB authentication information server which stores the H(e)NB authentication information profile, e.g., the authentication type of the H(e)NB. This is based on the H(e)NB ID provided by the H(e)NB in the IKE_AUTH request message. The SeGW may then decide whether to request certificate-based device authentication or EAP-AKA based authentication, based on the authentication profile.

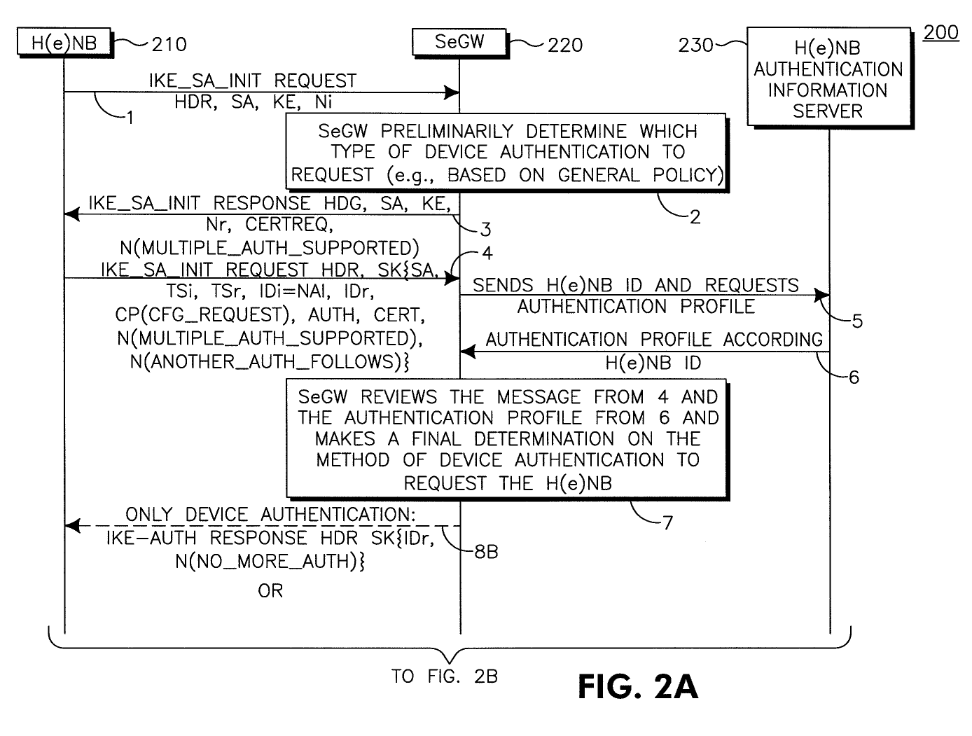

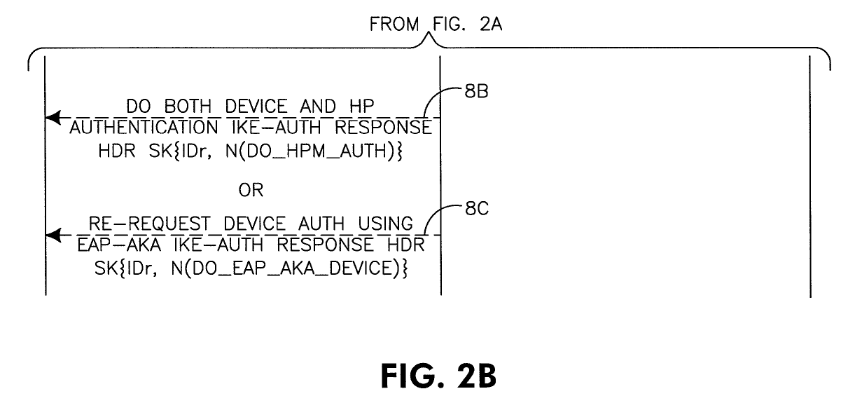

Referring to FIGS. 2A and 2B, there is shown an example flow 200 of an authentication method selection between an H(e)NB 210, a SeGW 220 and an H(e)NB authentication information server 230. The H(e)NB 210 first sends an IKE_SA_INIT (IKE security association initialization) request to the SeGW 220 (1).

After the SeGW 220 receives the first IKE_SA_INIT request for authentication from the H(e)NB 210, the SeGW 220 makes a preliminary decision on whether it will require just device authentication or both device and HPM authentication (2). Initially, the SeGW 220 may ask for multiple authentication, with certificate-based device authentication and EAP-AKA based HPM authentication, as a default option based on a general policy. For example, the SeGW 220 sends an IKE_SA_INIT response to the H(e)NB 210 requesting that the H(e)NB 210 perform certificate-based device authentication and EAP-AKA based HPM authentication (3).

The H(e)NB 210 indicates that it will comply with the previous request from the SeGW 220 by sending the AUTH for HPM authentication and the CERT for certificate-based device authentication (4). At this point, the SeGW 220 may still not (1) trust this indication from the H(e)NB 210 or (2) be certain whether it would be the best overall decision to perform multiple authentication with certificate-based device authentication and an EAP-AKA based HPM authentication.

If the SeGW 220 is not certain of the authentication method, the SeGW 220 may send the H(e)NB_ID that it receives from the H(e)NB to the H(e)NB authentication information server 230 and request an authentication profile for the H(e)NB 210 (5). The H(e)NB authentication information server 230 may be a Lightweight Directory Access Protocol (LDAP) server or similar entity, containing root certificates and that may be able to verify a certificate.

The SeGW 220 receives the authentication profile for this particular H(e)NB 210 from the H(e)NB authentication information server 230 (6). The SeGW 220 then makes a final decision on which type of authentication it will perform with the H(e)NB 210 based on the input from the H(e)NB in (4) and from the H(e)NB authentication information server 230 in (6) (7).

The SeGW's 220 final decision or determination on the authentication method may result in one of multiple outcomes. The SeGW 220 may decide not to allow the H(e)NB to perform HPM authentication (after it has just sent its CERT for certificate-based device authentication) and may indicate to the H(e)NB 210 not to initiate HPM authentication with it in an IKE-AUTH Response message but allow device authentication (8a). In another outcome, the SeGW 220 may decide to allow the H(e)NB 210 to perform HPM authentication and device authentication and indicate such to the H(e)NB 210 in an IKE-AUTH Response message (8b). In yet another outcome, the SeGW 220 may decide that it wants the H(e)NB 210 to perform an EAP-AKA based device authentication, and indicate to the H(e)NB 210 to use the IKE_AUTH Response message (8c). The SeGW 220 may perform any of the outcomes depending, in part, on the authentication profile of the H(e)NB 210 that was retrieved by the SeGW 220.

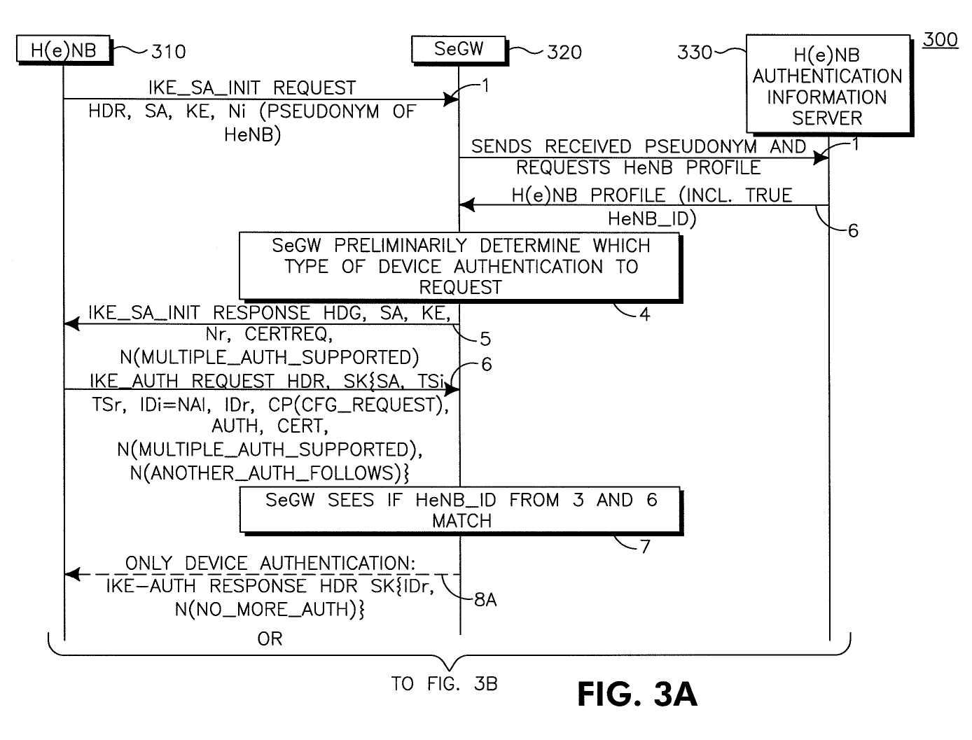

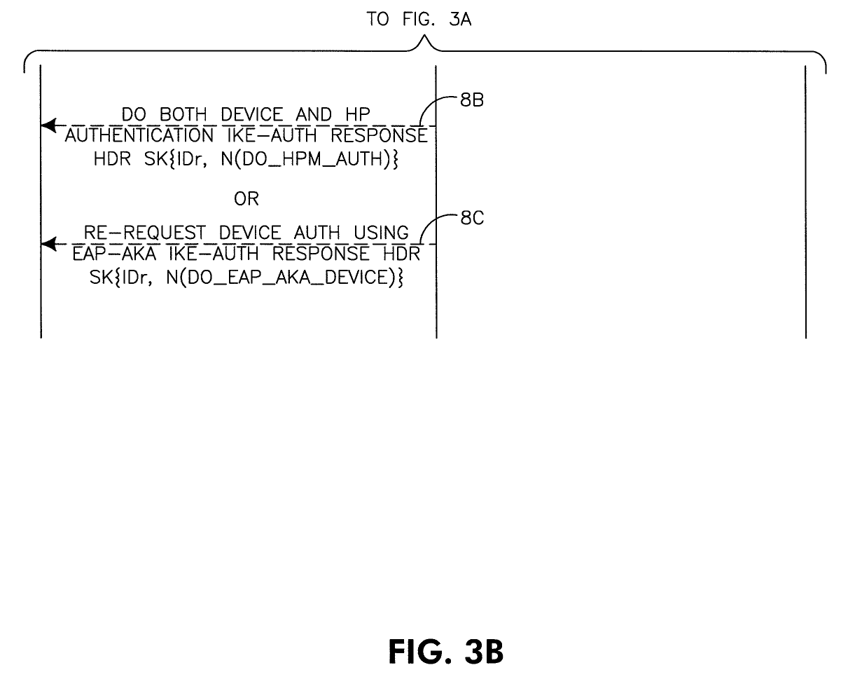

Referring now to FIGS. 3A and 3B, an example flow diagram 300 is shown of a second embodiment. A H(e)NB_ID may be indicated in the first message from the H(e)NB 310 to the SeGW 320 in the IKEv2 protocol, which is the IKE_SA_INIT message (1). The Notification message element of the IKE_SA_INIT message may be used to carry the H(e)NB_ID. Since this message is unprotected, the H(e)NB_ID may need to be protected, e.g., by using a pseudonym. Another option may be to use a previously established Security Association (SA) and the keys established during such a previous SA to protect the H(e)NB_ID information carried in a Notification message.

Once the SeGW 320 receives the HeNB_ID (either a pseudonym or a cryptographically protected ID), the SeGW 320 may either decrypt the ID and forward it to the H(e)NB authentication information server 330, or it could just forward the ID to the H(e)NB authentication information server 330 (2).

The H(e)NB authentication information server 330 then may search in its database for the received ID and determine the profile or information about the ID. The H(e)NB authentication information server 330 may either recommend the most appropriate method for H(e)NB authentication for the H(e)NB 310, or it may simply furnish raw information about the H(e)NB 310 to the SeGW 320 (3). The SeGW 320 then may make a preliminary determination of the “requirement” for the H(e)NB authentication (4). The H(e)NB authentication information server 330 may also send the SeGW 320 what its records show as the true ID of the H(e)NB 310, that is, the HeNB_ID (3).

When the H(e)NB 310 and the SeGW 320 have finished the IKE_SA_INIT phase and have mutually established new shared keys (using Diffie-Hellmann, according to the IKEv2 protocol) (5), the H(e)NB 310 may re-send the proper H(e)NB_ID using the network address identifier (NAI) field of the IKE_AUTH request message (6). After receiving this, the SeGW 320 may determine if the received ID matches the ID information about the H(e)NB 310 that the SeGW 320 had received from the H(e)NB authentication information server 330 (7). If the IDs match, the SeGW 320 may decide whether to accept or reject the authentication method that the H(e)NB 310 may have sent in the same IKE_AUTH message (6). If the IDs do not match, the SeGW 320 may reject the request and bar the H(e)NB 310 from further accessing the network and/or ask the H(e)NB 310 to re-authenticate.

As in embodiment one, the SeGW's 320 final decision or determination on the authentication method may result in one of multiple outcomes. The SeGW 320 may decide not to allow the H(e)NB to perform HPM authentication (after it has just sent its CERT for certificate-based device authentication) and may indicate to the H(e)NB 310 not to initiate HPM authentication with it in an IKE-AUTH Response message but allow device authentication (8a). In another outcome, the SeGW 320 may decide to allow the H(e)NB 310 to perform HPM authentication and device authentication and indicate to the H(e)NB 310 in an IKE-AUTH Response message (8b). In yet another outcome, the SeGW 320 may decide that it wants the H(e)NB 310 to perform an EAP-AKA based device authentication, and indicate to the H(e)NB 310 to use the IKE_AUTH Response message (8c). The SeGW 320 may perform any of the outcomes depending, in part, on the authentication profile of the H(e)NB 310 that was retrieved by the SeGW 320.

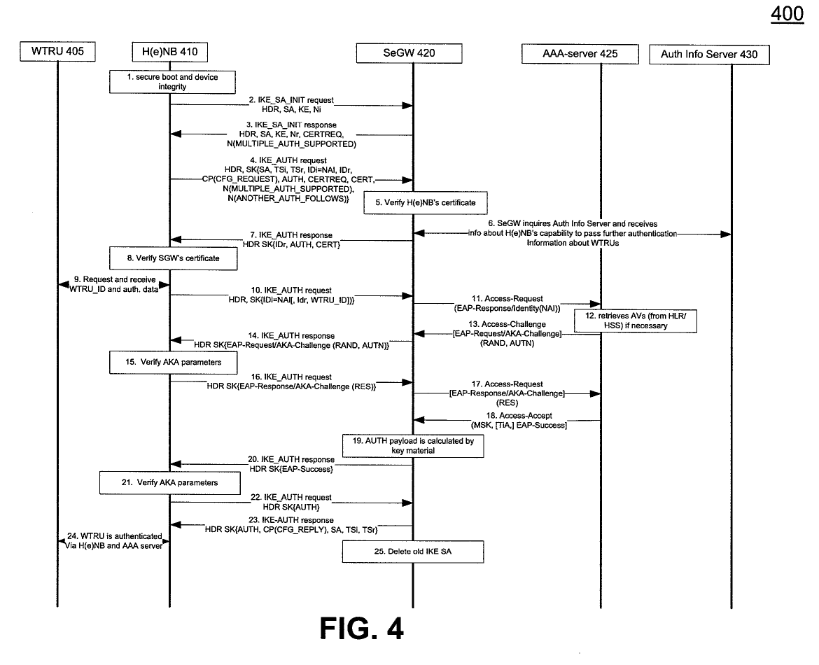

Referring now to FIG. 4, an example flow diagram 400 is shown of a third embodiment. First, the H(e)NB 410 securely boots and performs device integrity check (1). If the device integrity check fails, operations shown in (2) to (25) are not performed. Upon device integrity check success, the H(e)NB 410 sends an IKE_SA INIT request to the SeGW 420 (2). The SeGW 420 sends IKE_SA INIT response, requesting a certificate from the H(e)NB 410 (3). The SeGW 420 indicates that it support Multiple Authentication by including the MULTIPLE_AUTH_SUPPORTED payload (3). By including the MULTIPLE_AUTH_SUPPORTED, the SeGW 420 indicates to the H(e)N 410 that it supports authentication of both the H(e)NB 410 and one or more WTRUs 405 connected or attempting to connect to the H(e)NB 410.

The H(e)NB 410 inserts its identity in the IDi payload in this first message of the IKE_AUTH phase, computes the AUTH parameter (preferably within a trusted environment within the H(e)NB), and begins negotiation of child security associations (4). The authentication type indication in user profile which is selected by H(e)NB's identity presented in the IDi payload may be used and enforce the choice of authentication (in this example, the choice would be H(e)NB device authentication plus WTRU authentication based on EAP-AKA, as exemplified in this embodiment). The H(e)NB 410 then sends IKE_AUTH request (4) with the AUTH payload, its own certificate, and also requests a certificate from the SeGW 420 Configuration payload is carried in this message if the H(e)NB's remote IP address should be configured dynamically. The H(e)NB 410 indicates that it support Multiple Authentication and that it wants to do a second authentication by including the MULTIPLE_AUTH_SUPPORTED and ANOTHER_AUTH_FOLLOWS attributes. The use of MULTIPLE_AUTH_SUPPORTED and ANOTHER_AUTH_FOLLOWS indicates that the H(e)NB 410, will perform authentication procedures for both itself (H(e)NB 410) and one or more WTRU(s) 405 connected to or attempting to connect to it. If configured to check the validity of the SeGW certificate the H(e)NB retrieves SeGW certificate status information from the OCSP responder. Alternatively the H(e)NB may add an OCSP request to the IKE message.

The SeGW 420 checks the correctness of the AUTH received from the H(e)NB 410 and calculates the AUTH parameter which authenticates the second IKE_SA_INIT message (5). The SeGW 420 verifies the certificate received from the H(e)NB 410. The SeGW 420 may check the validity of the certificates using Certificate Revocation List (CRL) or Online Certificate Status Protocol (OCSP), both of which are well-known protocols for managing certificates and their validity statuses.

The SeGW 420 also inquires the Authentication Information Server 430 and receives information about H(e)NB's capability to pass further authentication information about the WTRU(s) connected to or attempting to connect to it to the AAA server 425, or to partake in the authentication of the WTRU(s) connected to or attempting to connect to it by itself (6).

If, in (6), the Authentication Information Server 430 indicates to the SeGW 420 that the H(e)NB 420 is capable of performing steps for authentication for both itself and one or more WTRU(s) connected to or attempting to connect to it, then, in (7), the SeGW 420 sends IKE_AUTH response with its identity in the IDr payload, the AUTH parameter and its certificate to the H(e)NB 410. Otherwise, the protocol stops here. If the SeGW 420 has SeGW certificate status information available, this information is added to the IKE response to H(e)NB 410.

The H(e)NB 410 verifies the SeGW certificate with its stored root certificate (8). The H(e)NB 410 checks that the SeGW identity as contained in the SeGW certificate equals the SeGW identity as provided to H(e)NB by initial configuration or as previously provided by the network entity that manages the general, configuration/performance/fault management of H(e)NB. Note that in 3GPP, the Home (e)NB Management Sub-system (H(e)MS) is such an entity. The H(e)NB 410 checks the validity of the SeGW certificates using the OCSP response if configured to do so (see 7).

The H(e)NB 410 requests and then receives from the WTRU(s) 405 connected to or attempting to connect to it it's (or their) ID(s) (WTRU_ID(s)), and all other authentication credential information that the H(e)NB 410 can use to compute any authentication challenge response results for the WTRU(s) 405 to authenticate them to the AAA server 4250 (9).

The processes in (10) to (25) hereafter disclose an embodiment where the AAA-server 425 authenticates the WTRU(s) 405, while the H(e)NB 410 passes along the ID(s) and authentication credential information of the WTRU(s) 405 to the AAA-server. The H(e)NB 410 sends another IKE_AUTH request message with the WTRU's identity in the IDi payload and the AUTH payload omitted to inform the SeGW 420 that the H(e)NB 410 want to perform EAP authentication for the WTRUs 405 (10).

The SeGW 420 sends the Authentication Request message with an empty EAP AVP (11) to the 3GPP AAA Server 425 containing the identity received in IKE_AUTH request message received in (10).

The AAA Server 425 fetches any authentication vectors for the WTRUs from HSS/HLR, if necessary, to use in the further steps of authenticating the WTRUs 405 (12).

The AAA Server 425 initiates an authentication challenge. (13)

The SeGW 420 sends IKE_AUTH response to H(e)NB 410. The EAP message (called EAP-Request/AKA-Challenge herein) received from the AAA Server 425 is included in order to start the EAP procedure over IKEv2 (14).

The H(e)NB 410 processes the EAP challenge message and uses the WTRU-authentication credential information it received from WTRU(s) in Step 9 to verify the AUTN and generating the RES parameters, on behalf of the WTRU(s) 405 (15). The verification of the AUTN and the generation of the RES parameters should preferably take place within a trusted environment of the H(e)NB, on behalf of the WTRU(s). Optionally, processing of the whole EAP challenge message on behalf of the WTRU(s) 405, including verification of the received MAC with the newly derived keying material may be performed within the H(e)NB 410, again preferably within a trusted environment in the H(e)NB 410.

The H(e)NB 410 sends the IKE_AUTH request with the EAP-Response/AKA-Challenge to the SeGW 420, on behalf of the WTRU(s) 405 (16).

The SeGW forwards the EAP-Response/AKA-Challenge message to the AAA Server 425 (17).

When all checks are successful, the AAA Server 425 sends the Authentication Answer including an EAP success and the key material to the SeGW 420. This key material should consist of the Master Storage Key (MSK) generated during the EAP-based authentication process (18).

The SeGW 420 uses the MSK to generate the AUTH parameters in order to authenticate the IKE_SA_INIT phase messages (19).

The H(e)NB 420 forwards the EAP Success message to the H(e)NB 410 over IKEv2 (20).

The H(e)NB 410 takes its own copy of the MSK as input to generate the AUTH parameter to authenticate the first IKE_SA_INIT message, on behalf of the WTRU(s) 405 (21). Computation of the AUTH parameter is performed within the H(e)NB's trusted environment.

The H(e)NB 410 sends the IKE_AUTH request with the AUTH parameter to the SeGW 420, on behalf of the WTRU(s) 405 (22).

The SeGW 420 checks the correctness of the AUTH received from the H(e)NB 410 and calculates the AUTH parameter which authenticates the second IKE_SA_INIT message (23). The SeGW 420 should send the assigned Remote IP address in the configuration payload (CFG_REPLY) that the H(e)NB 410 then can forward to the WTRU(s) so that it (they) could be assigned such Remote IP address, if the H(e)NB requested for a Remote IP address through the CFG_REQUES. Then the SeGW 420 sends the IKE_AUTH response with AUTH parameter to the H(e)NB together with the configuration payload, security associations and the rest of the IKEv2 parameters, all on behalf of the WTRU(s) 405, and the IKEv2 negotiation terminates.

The H(e)NB 410 indicates to the WTRU(s) 405 that it is (or they are) now authenticated to the network operator (24). Such indication should preferably be secured for confidentiality, authenticity (for the H(e)NB as the sender's identity), and integrity.

If the SeGW 420 detects that one or more old IKE SA(s) for the WTRU(s) 405 that are connected to H(e)NB 410 already exists (or exist), it will delete the IKE SA(s) and send the H(e)NB an INFORMATIONAL exchange with a Delete payload in order to delete any old IKE SA(s) corresponding to the WTRU(s) 405 that are stored in the H(e)NB 410 (25).

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for authenticating a home nodeB/home enhanced node B (H(e)NB) with a network, comprising:
receiving an authentication request;
providing a first requirement determination for one of device authentication or device authentication and hosting party authentication; and
providing a second requirement determination based on an H(e)NB profile information, for one of the device authentication or device authentication and hosting party authentication.

2. The method of claim 1, further comprising receiving an Internet Key Exchange security association initialization (IKE_SA_INIT) request from the H(e)NB.

3. The method of claim 1, wherein the providing the first requirement determination is based on a predetermined policy.

4. The method of claim 1, further comprising:
sending an IKE_SA_INIT response to the H(e)NB; and
receiving an IKE_AUTH request from the H(e)NB;

5. The method of claim 1, further comprising sending an H(e)NB identifier to an authentication information server.

6. The method of claim 5, further comprising requesting an authentication profile for the H(e)NB from the authentication information server.

7. The method of claim 6, further comprising receiving the authentication profile for the H(e)NB from the authentication information server.

8. The method of claim 1, wherein providing a second requirement determination comprises reviewing an IKE_AUTH request and an authentication profile to determine an authentication method.

9. The method of claim 1, further comprising sending an IKE_AUTH response to the H(e)NB.

10. The method of claim 9, wherein the IKE_AUTH response indicates one of device authentication or device authentication and hosting party authentication are to be performed.

11. The method of claim 9, wherein the IKE_AUTH response indicates that the H(e)NB re-request device authentication using Extensible Authentication Protocol-Authentication and Key Agreement.

12. The method of claim 2, wherein the IKE_SA_INIT request includes a pseudonym for the H(e)NB.

13. The method of claim 12, further comprising sending the pseudonym to an authentication information server.

14. The method of claim 13, further comprising requesting an H(e)NB profile from the authentication information server.

15. The method of claim 14, further comprising receiving the H(e)NB profile from the authentication information server.

16. The method of claim 15, wherein the H(e)NB profile includes a true H(e)NB identifier.

17. The method of claim 16, further comprising receiving an IKE_AUTH request with an H(e)NB identifier.

18. The method of claim 17, further comprising comparing the true H(e)NB identifier in the H(e)NB profile with the H(e)NB identifier in the IKE_AUTH request.

19. A method for selecting a home enhanced Node B (H(e)NB) authentication method, comprising:
sending an Internet Key Exchange security association initialization (IKE_SA_INIT) request to a security gateway (SeGW);
receiving a first requirement determination by the SeGW for one of device authentication or device authentication and hosting party authentication; and
receiving a second requirement determination by the SeGW based on a home enhanced Node B (H(e)NB) profile information, for one of the device authentication or device authentication and hosting party authentication.

20. A method implemented in a home enhanced Node B (H(e)NB) for authenticating the H(e)NB and at least one wireless transmit/receive unit (WTRU) via a security gateway (SeGW), the method comprising:
transmitting a request for WTRU ID and WTRU authentication credential information to the at least one WTRU;
receiving the WTRU ID and WTRU authentication credential information from the at least one WTRU;
computing WTRU authentication information out of WTRU authentication credential information;
transmitting H(e)NB authentication information and the WTRU ID and WTRU authentication information to the SeGW;
receiving a successful H(e)NB authentication indication and a successful WTRU authentication indication from the SeGW.

21. The method of claim 20 further comprising transmitting the H(e)NB authentication information and the WTRU ID and WTRU authentication information to the SeGW in separate messages.

22. The method of claim 20 further comprising receiving an indication of capability to authenticate both the H(e)NB and the at least one WTRU from the SeGW.

23. The method of claim 22 further comprising transmitting indication of capability to support authentication of both the H(e)NB and the at least one WTRU to the SeGW.

24. The method of claim 20 further comprising transmitting an indication of successful authentication to the at least one WTRU.

25. A home enhanced Node B (H(e)NB), comprising:
the H(e)NB configured to send an Internet Key Exchange security association initialization (IKE_SA_INIT) request to a security gateway (SeGW);
the H(e)NB configured to receive a first requirement determination by the SeGW for one of device authentication or device authentication and hosting party authentication; and
the H(e)NB configured to receive a second requirement determination by the SeGW based on an H(e)NB profile information, for one of the device authentication or device authentication and hosting party authentication.

26. The H(e)NB of claim 25 further comprising:
the H(e)NB, acting as a proxy on behalf of at least one wireless transmit/receive unit (WTRU), the H(e)NB being configured to perform authentication processing for the at least one WTRU.

27. The H(e)NB of claim 25 further comprising:
the H(e)NB configured to send authentication information to the SeGW on behalf of the at least one WTRU.

28. The H(e)NB of claim 25 further comprising:
the H(e)NB configured to send authentication information to at least one WTRU on behalf of the SeGW.

29. The H(e)NB of claim 25 further comprising:
the H(e)NB configured to perform authentication processing a trusted environment within it.
